(19) United States
(12) Patent Application Publication
(10) Pub. No.: US 2004/0214698 A1
(43) Pub. Date: Oct. 28, 2004

(54) Airshaft

(76) Inventor: Hsi-Tsai Chen, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/616,041

(22) Filed: Jul. 8, 2003

(30) Foreign Application Priority Data
Apr. 22, 2003 (TW) 092206368

(51) Int. Cl. B29C 43/46

(52) U.S. Cl. 492/4

(57) ABSTRACT

An airshaft includes a shaft body having a shaft axis, and an outer shaft surface formed with at least three bladder retaining grooves. Each bladder retaining groove is generally inverted T-shaped, and has a narrower access opening formed in the shaft surface and a wider retaining section disposed between the access opening and the shaft axis. An inflatable bladder member is received in the retaining section of each retaining groove. Each of a plurality of roll contact pieces is disposed in the retaining section of a respective retaining groove, is biased by the inflatable bladder member in the respective retaining groove, and extends out of the access opening of the respective retaining groove. The roll contact pieces include a set of first roll contact pieces and a set of second roll contact pieces. The second roll contact pieces have a height shorter than that of the first roll contact pieces.

### CROSS-REFERENCE TO RELATED APPLICATION

This application claims priority of Taiwanese application no. 092206368, filed on Apr. 22, 2003.

### BACKGROUND OF THE INVENTION

1. Field of the Invention

The invention relates to an airshaft, more particularly to an airshaft that is capable of holding a roll of web material.

2. Description of the Related Art

An airshaft is mounted rotatably on a machine, and is expandable by use of pressurized air so as to hold a roll of web material, such as paper, rubber, plastic, metal, fabric, wire, or the like, thereon.

As shown in FIGS. 1 and 2, a conventional airshaft includes a shaft body 11 and an inflatable unit 12 retained on the shaft body 11. The inflatable unit 12 includes a plurality of inflatable bladder members that, when inflated, protrude from the surface of the shaft body 11 to abut against a roll 2 of web material sleeved on the airshaft so as to hold the roll 2 on the shaft body 11. The roll 2 generally includes a cardboard tubular core or a metal tubular core. In use, an inner diameter of the roll 2 is larger than an outer diameter of the shaft body 11. Accordingly, when the inflatable unit 12 is inflated, the inflatable unit 12 expands in radial outward directions to be able to hold the roll 2 on the shaft body 11.

It is noted that the greater the extent of expansion of the inflatable unit 12, the larger will be the holding force exerted on the roll 2 to ensure rotation of the roll 2 with the shaft body 11. However, when the extent of expansion of the inflatable unit 12 is unduly large, the degree of rotational concentricity of the roll 2 with respect to the shaft body 11 will be adversely affected in view of deformation of the roll 2 at contact areas with the inflatable unit 12 such that, when the shaft body 11 rotates about an axis thereof, rotational deviation of the web material being wound on the roll 2 is likely to occur. This problem is aggravated under high-speed conditions and during heavy web material applications. The aforesaid rotational deviation not only affects production quality, but also subjects the shaft body 11 to imbalanced forces that can interrupt production and that can shorten the service life of the airshaft.

### SUMMARY OF THE INVENTION

Therefore, the object of the present invention is to provide an airshaft that can overcome the aforesaid drawbacks associated with the prior art.

Accordingly, an airshaft of this invention comprises:

an elongate shaft body having a shaft axis and an outer cylindrical shaft surface formed with at least three longitudinally extending bladder retaining grooves, each of the bladder retaining grooves being generally inverted T-shaped and having a narrower access opening formed in the shaft surface and a wider retaining section disposed between the access opening and the shaft axis;

a set of elongate inflatable bladder members, each of which is received in the retaining section of a respective one of the retaining grooves; and

a plurality of roll contact pieces, each of which has a biased side disposed in the retaining section of one of the retaining grooves and in contact with the inflatable bladder member in the corresponding retaining groove, and a roll contacting side extending out of the corresponding retaining groove through the access opening of the corresponding retaining groove, the roll contacting side having a distal contact face.

The roll contact pieces include a set of first roll contact pieces and a set of second roll contact pieces. The distal contact face of the roll contacting side of each of the first roll contact pieces forms a first height with the inflatable bladder member in the corresponding retaining groove. The distal contact face of the roll contacting side of each of the second roll contact pieces forms a second height with the inflatable bladder member in the corresponding retaining groove. The second height is shorter than the first height.

When a roll of web material is sleeved on the shaft body, and when the inflatable bladder members are inflated, the distal contact faces of the roll contacting sides of the first roll contact pieces contact the roll of web material for holding the roll of web material on the shaft body, and the distal contact faces of the roll contacting sides of the second roll contact pieces contact the roll of web material for positioning stably the roll of web material on the shaft body.

### BRIEF DESCRIPTION OF THE DRAWINGS

Other features and advantages of the present invention will be come apparent in the following detailed description of the preferred embodiments with reference to the accompanying drawings, of which:

FIG. 1 is a schematic partly sectional view of a conventional airshaft;

FIG. 2 is a magnified view of an encircled portion of the conventional airshaft of FIG. 1;

FIG. 3 is an assembled sectional view of the first preferred embodiment of an airshaft according to the present invention;

FIG. 4 is an assembled fragmentary perspective view of the first preferred embodiment;

FIG. 5 is a fragmentary assembled sectional view of the first preferred embodiment; and

FIG. 6 is an assembled perspective view of the second preferred embodiment of an airshaft according to the present invention.

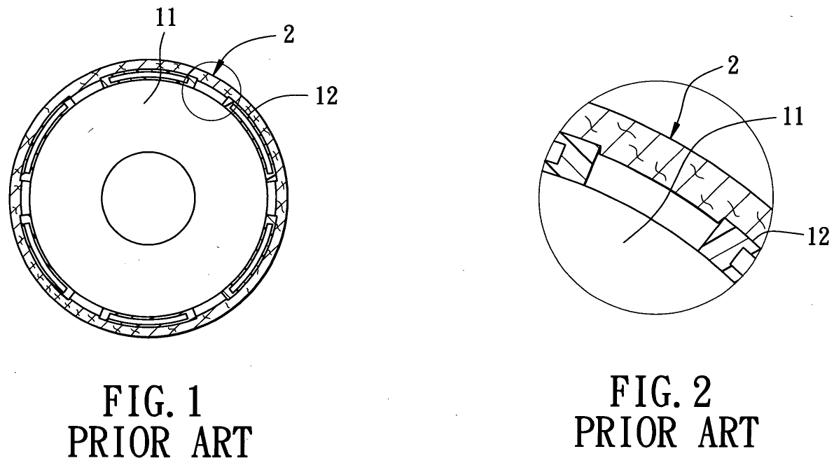

### DETAILED DESCRIPTION OF THE PREFERRED EMBODIMENTS

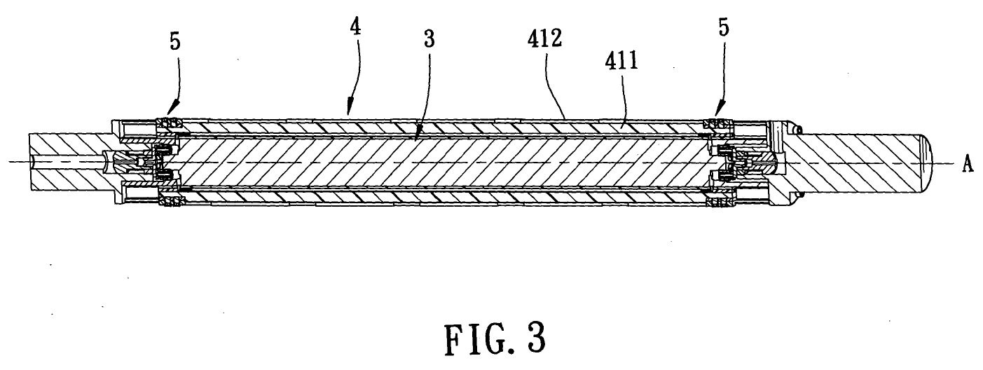

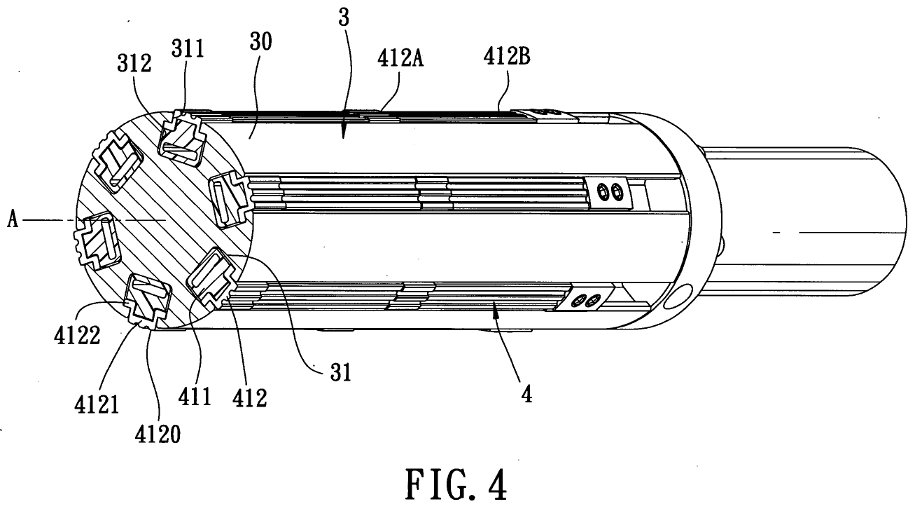

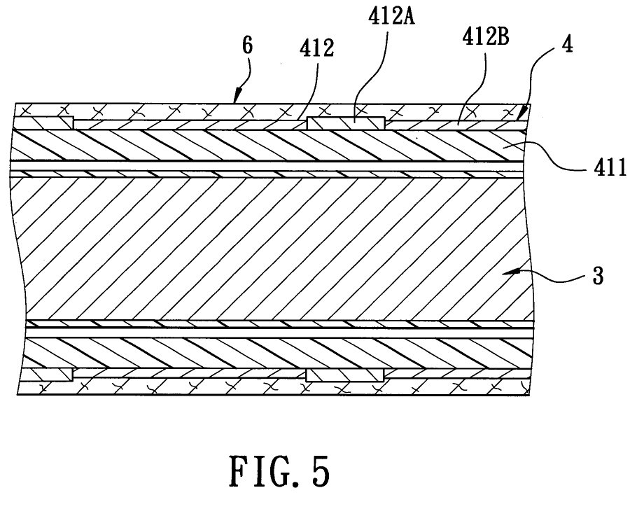

As shown in FIGS. 3, 4 and 5, the first preferred embodiment of an airshaft according to this invention is shown to include a shaft body 3, an inflatable unit 4 retained on the shaft body 3, and an air pumping unit 5 connected to the inflatable unit 4.

The shaft body 3 has a shaft axis (A), and an outer cylindrical shaft surface 30 formed with at least three longitudinally extending bladder retaining grooves 31. Each of the bladder retaining grooves 31 is generally inverted T-shaped, and has a narrower access opening 311 formed in the shaft surface 30 and a wider retaining section 312 disposed between the access opening 311 and the shaft axis (A). In this embodiment, each of the bladder retaining grooves 31 extends parallel to the shaft axis (A).

The inflatable unit 4 includes a set of elongate inflatable bladder members 411 and a plurality of roll contact pieces 412. Each inflatable bladder member 411 is received in the retaining section 312 of a respective one of the bladder retaining grooves 31. Each roll contact piece 412 has a biased side 4122 disposed in the retaining section 312 of one of the retaining grooves 31 and in contact with the inflatable bladder member 411 in the corresponding retaining groove 31, and a roll contacting side 4121 extending out of the corresponding retaining groove 31 through the access opening 311 of the corresponding retaining groove 31. The roll contacting side 4121 has a distal contact face 4120 distal from the inflatable bladder member 411 in the corresponding retaining groove 31.

The roll contact pieces 412 include a set of first roll contact pieces 412A and a set of second roll contact pieces 412B. The distal contact face 4120 of the roll contacting side 4121 of each of the first roll contact pieces 412A forms a first height with the inflatable bladder member 411 in the corresponding retaining groove 31. The distal contact face 4120 of the roll contacting side 4121 of each of the second roll contact pieces 412B forms a second height with the inflatable bladder member 411 in the corresponding retaining groove 31. The second height is shorter than the first height.

In this embodiment, the roll contact pieces 412 are disposed side-by-side on the inflatable bladder member 411 in the corresponding retaining groove 31. Moreover, a total area of the distal contact faces 4120 of the roll contacting sides 4121 of the first roll contact pieces 412A is less than that of the distal contact faces 4120 of the roll contacting sides 4121 of the second roll contact pieces 412B.

The air pumping unit 5 is connected to the inflatable bladder members 411 and is operable so as to inflate the inflatable bladder members 411.

In use, when a roll 6 of web material is sleeved on the shaft body 3, and when the inflatable bladder members 411 are inflated with the use of the air pumping unit 5, the inflatable bladder members 411 expand in radial outward directions such that the distal contact faces 4120 of the roll contacting sides 4121 of the first roll contact pieces 412A contact the roll 6 of web material to exert a stronger force sufficient for holding the roll 6 of web material on the shaft body 3, thereby preventing removal of the roll 6 from the shaft body 3, whereas the distal contact faces 4120 of the roll contacting sides 4121 of the second roll contact pieces 412B contact the roll 6 of web material to exert a weaker force sufficient for positioning stably the roll 6 of web material on the shaft body 3, thereby maintaining rotational concentricity of the roll 6 with respect to the shaft axis (A).

Therefore, in practice, the length of the first roll contact pieces 412A does not have to be too long to achieve the intended effect of holding the roll 6 of web material on the shaft body 3. Moreover, the second height of the second roll contact pieces 412B is only required to be large enough to position stably the roll 6 of web material 6 such that the second roll contact pieces 412B do not press tightly against the roll 6 of web material to avoid the undesired rotational deviation commonly encountered in the prior art. As such, because two complementary holding and positioning effects are respectively attributed to the first and second roll contact pieces 412A, 412B, the roll 6 of web material will not encounter the problem of rotational deviation during use of the airshaft of this invention so that a smooth rolling operation is ensured and so that the service life of the airshaft can be prolonged.

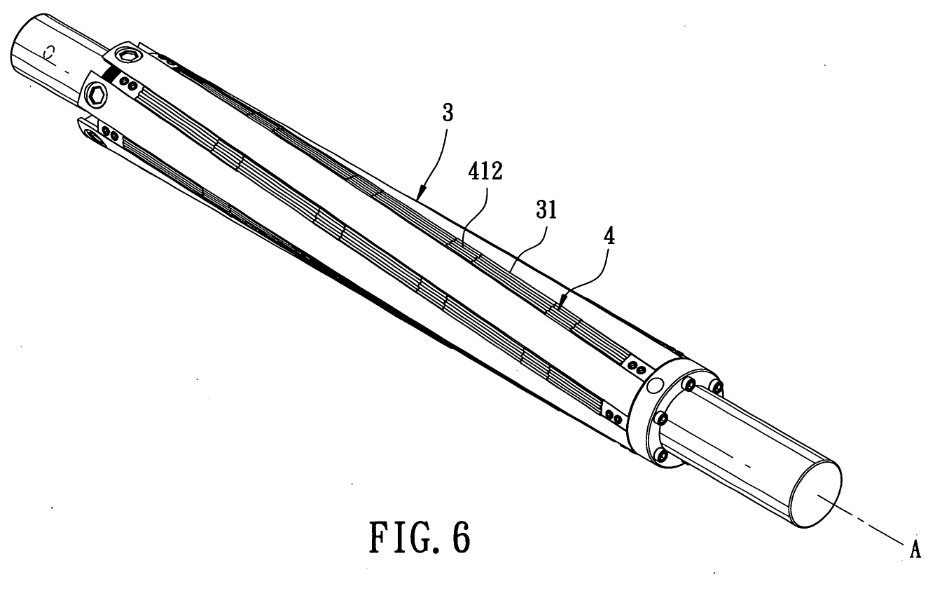

FIG. 6 illustrates the second preferred embodiment of an airshaft according to this invention. Unlike the first preferred embodiment, each of the bladder retaining grooves 31 in the embodiment of FIG. 6 extends along a twisted line with respect to the shaft axis (A). The resulting helical arrangement of the roll contact pieces 412 on the shaft body 3 enhances the rotational concentricity of the roll of web material during rotation of the shaft body 3.

While the present invention has be en described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An airshaft for holding a roll of web material, comprising:
an elongate shaft body having a shaft axis and an outer cylindrical shaft surface formed with at least three longitudinally extending bladder retaining grooves, each of said bladder retaining grooves being generally inverted T-shaped and having a narrower access opening formed in said shaft surface and a wider retaining section disposed between said access opening and said shaft axis;
a set of elongate inflatable bladder members, each of which is received in said retaining section of a respective one of said retaining grooves; and
a plurality of roll contact pieces, each of which has a biased side disposed in said retaining section of one of said retaining grooves and in contact with said inflatable bladder member in said one of said retaining grooves, and a roll contacting side extending out of said one of said retaining grooves through said access opening of said one of said retaining grooves, said roll contacting side having a distal contact face;
wherein said roll contact pieces include a set of first roll contact pieces and a set of second roll contact pieces, said distal contact face of said roll contacting side of each of said first roll contact pieces forming a first height with said inflatable bladder member in said one of said retaining grooves, said distal contact face of said roll contacting side of each of said second roll contact pieces forming a second height with said inflatable bladder member in said one of said retaining grooves, said second height being shorter than said first height;
whereby, when the roll of web material is sleeved on said shaft body, and when said inflatable bladder members are inflated, said distal contact faces of said roll contacting sides of said first roll contact pieces contact the roll of web material for holding the roll of web material on said shaft body, and said distal contact faces of said roll contacting sides of said second roll contact pieces contact the roll of web material for positioning stably the roll of web material on said shaft body.

2. The airshaft as claimed in claim 1, wherein a total area of said distal contact faces of said roll contacting sides of said first roll contact pieces is less than that of said distal contact faces of said roll contacting sides of said second roll contact pieces.

3. The airshaft as claimed in claim 1, wherein each of said bladder retaining grooves extends parallel to the shaft axis.

4. The airshaft as claimed in claim 1, wherein each of said bladder retaining grooves extends along a twisted line with respect to the shaft axis.

5. The airshaft as claimed in claim 1, further comprising an air pumping unit connected to said inflatable bladder members and operable so as to inflate said inflatable bladder members.

6. The airshaft as claimed in claim 1, wherein said roll contact pieces are disposed side-by-side on said inflatable bladder member in said one of said retaining grooves.
